(19) United States
(12) Patent Application Publication
(10) Pub. No.: US 2021/0256620 A1
(43) Pub. Date: Aug. 19, 2021

(54) DYNAMIC APPLICATION INTERFACE IMPLEMENTING LAYERS TO PROVIDE A CUSTOM NAVIGATION USER EXPERIENCE

(71) Applicant: STATE FARM MUTUAL AUTOMOBILE INSURANCE COMPANY, Bloomington, IL (US)

(72) Inventors: John Howard Mendenhall, Bloomington, IL (US); Andres Sulleiro, Bloomington, IL (US); Lisa M. Smith, Bloomington, IL (US); Julie Robertson, Normal, IL (US); Don Paul, Bloomington, IL (US); Melanie Perschnick, Bloomington, IL (US); Sunni Barbera, Evanston, IL (US); Chris Giesler, Elmhurst, IL (US); Aaron Shimer, Evanston, IL (US); Nathon Turner, Bloomington, IL (US)

(21) Appl. No.: 17/206,690

(22) Filed: Mar. 19, 2021

Related U.S. Application Data
(63) Continuation of application No. 14/816,308, filed on Aug. 3, 2015.
(60) Provisional application No. 62/047,898, filed on Sep. 9, 2014.

(51) Int. Cl. G06Q 40/08

(52) U.S. Cl. CPC G06Q 40/08

(57) ABSTRACT

Method, apparatus, systems, and non-transitory media are described to simplify a user's interaction with a quoting application. Some data ordinarily requested by the user may be found from one of several private, public, and/or proprietary sources, so some prompts that would ordinarily need to be answered by the user may be eliminated. The described aspects also include retrieving data associated with one or more prompts, making assumptions about the user from the data, and using this data to prepopulate prompts. A control option indicative of a user's desired level of interaction with the application may affect the number of assumptions made and the number of omitted and/or prepopulated prompts presented to the user. By supplementing the user's prompt answers with database data, the number of prompts that need to be answered by the user may be reduced, thereby saving time for the user.

### CROSS REFERENCE TO RELATED APPLICATIONS

The present application is a continuation of, and claims the benefit of, U.S. patent application Ser. No. 14/816,308, entitled “Dynamic Application Interface Implementing Layers to Provide a Custom Navigation User Experience,” filed Aug. 3, 2015, which claims the benefit of U.S. Provisional Patent Application No. 62/047,898, entitled “Dynamic Application Interface Implementing Layers to Provide a Custom Navigation User Experience,” filed Sep. 9, 2014, all of which are hereby expressly incorporated by reference herein in their entirety.

### FIELD OF THE DISCLOSURE

The present disclosure relates to systems, methods, apparatus, and non-transitory computer readable media for use in generating a quote of a product for display on a graphical user interface (GUI).

### BACKGROUND

Often, various entities that provide products to customers may use online applications to gather information from their customers to provide premium quotes via the Internet. To do so, entities typically require various amounts of information based upon the type of product that is being quoted. To provide a customer with an accurate premium quote, the customer may answer a number of presented questions to provide the entity with the requisite information.

The questions presented to the customer may be numerous, and as a result the overall process of obtaining a quote may be lengthy. Thus, the customer's interaction with an online quote application process may be burdensome. Therefore, providing accurate quotes while maintaining a convenient and practical online application user experience presents several challenges.

### BRIEF SUMMARY

In some aspects, method, apparatus, systems, and non-transitory media are described that may, inter alia, simplify a user's interaction with a quoting application. Some data ordinarily requested from the user may be found from one of several private, public, and/or proprietary sources. The described aspects include a smart engine making assumptions about the user based upon data retrieved from one or more of these sources to attempt to anticipate the user's answers. Using these assumptions, aspects include eliminating or prepopulating prompts based upon data retrieved from these data sources that would ordinarily be presented to the user and/or need to be answered by the user. The described aspects also include a smart engine determining a minimal amount of information that is needed to calculate a premium quote, taking into account the data retrieved from these data sources. Once the data is received from the data sources and/or entered by the user, aspects include calculating a premium quote as requested by the user. Therefore, in some instances, the user may be able to provide only a minimal amount of information to obtain a premium quote.

The described aspects may include providing the user with a control option indicative of a user's desired level of interaction with the application, which may affect the number of assumptions made and the number of omitted and/or prepopulated prompts presented to the user. The described aspects may also include the smart engine providing the user with a customized user experience as the user interacts with the application based upon the user's selected control option. Once the user has started using the application, the described aspects also include providing the user with information regarding how assumptions were made and may also allow the user to change prepopulated or user preselected fields to facilitate greater user control.

### BRIEF DESCRIPTION OF THE DRAWINGS

The figures described below depict various aspects of the system and methods disclosed herein. It should be understood that each figure depicts an aspect of a particular aspect of the disclosed system and methods, and that each of the figures is intended to accord with a possible aspect thereof. Further, wherever possible, the following description refers to the reference numerals included in the following figures, in which features depicted in multiple figures are designated with consistent reference numerals.

FIG. 1 illustrates a block diagram of an exemplary online application system 100 in accordance with one aspect of the present disclosure;

FIG. 2 illustrates a block diagram of an exemplary smart quoting engine 200 in accordance with one aspect of the present disclosure;

FIG. 3 illustrates a block diagram 300 of various exemplary user experience paths in accordance with one aspect of the present disclosure;

FIG. 4A illustrates a block diagram 400 of various exemplary user experience paths for obtaining an automotive insurance quote using prepopulated prompts in accordance with one aspect of the present disclosure;

FIG. 4B illustrates a block diagram 450 of various exemplary user experience paths for obtaining a homeowners insurance quote using prepopulated prompts in accordance with one aspect of the present disclosure;

FIG. 4C illustrates a block diagram 470 of various exemplary user experience paths for obtaining an automotive insurance quote by omitting prompts in accordance with one aspect of the present disclosure;

FIG. 5A is an exemplary screenshot 500 of an application window having one or more prepopulated fields in accordance with an aspect of the present disclosure.

FIG. 5B is an exemplary screenshot 550 of an application window having one or more prepopulated fields in accordance with an aspect of the present disclosure.

FIG. 6 illustrates an exemplary method 600 in accordance with one aspect of the present disclosure;

FIG. 7 illustrates an exemplary method 700 in accordance with one aspect of the present disclosure; and

FIG. 8 illustrates a block diagram 800 in accordance with an exemplary aspect of the present disclosure.

Although the following text sets forth a detailed description of numerous different aspects, it should be understood that the legal scope of the description is defined by the words of the claims set forth at the end of this patent. The detailed description is to be construed as exemplary only and does not describe every possible aspect since describing every possible aspect would be impractical, if not impossible. Numerous alternative aspects may be implemented, using either current technology or technology developed after the filing date of this patent, which would still fall within the scope of the claims.

### DETAILED DESCRIPTION

The present embodiments may, inter alia, provide a layered user experience for online transactions. A method and system may simplify and streamline user interactions while providing information which may give the user high confidence that their needs are being met. The method and system may allow customers to interact with their insurance or financial services provider quickly and efficiently, as well as facilitate customer understanding and comprehension of various options. As a result, customers may be assured that they are making the best and most-informed decisions.

In one aspect, the user online experience may be improved by guiding the user through various processes (e.g., purchasing or updating insurance policies). The online experience may require the user to enter minimal information to complete a given task, while also promptly displaying relevant information about resulting choices and/or user performed operations. Within this streamlined flow, the user may receive more detailed information if desired and/or compare different product options that they may choose from.

A customer may opt-in to an insurance program in which an insurance provider remote server, with customer permission, may analyze customer information and/or make insurance-related recommendations. Further, the present embodiments may make certain assumptions for customers, such as assumptions related to wants and needs, based upon the data analysis. As an example, based upon mobile device GPS location or other information, it may be assumed that a state-to-state move has occurred and/or that the customer needs to update insurance policies (home, auto, etc.) accordingly.

The data analyzed may originate from several sources. However, the input required and information desired may be different for each customer. The present embodiments may utilize all relevant information about the customer and the insured assets to optimally tailor the experience and offer intelligent, personalized options and results for the user's consideration.

The present embodiments may optimally request and/or display the minimum amount of information that is necessary to satisfy a large majority of customers in the streamlined flow such that they do not feel the need to expend the time and energy to dig deeper. All detailed information may be available or accessible by customers if they so desire, but high satisfaction for customers may be achieved by a simple and efficient interaction that provides a significant level of comfort that an optimal result was achieved.

The present techniques may also prepopulate certain fields, such as fields associated with an online application for insurance. However, rather than simply prepopulating fields based upon knowledge of the customer and their assets, the present techniques may present the customers with a simpler, customized experience that doesn't burden them with extraneous information. In one aspect, a few key questions may be asked, and then a proposed product may be provided. If the customer is interested in more details, they may drill down to retrieve it from an insurance quote application.

The layered experience of the present embodiments may include several features, including: (1) customers may have the ability to review information, customize results and/or transact in as much or as little detail as they see fit; (2) using multiple data sources, including company information and public records, and/or emerging technologies, customers may be provided with simplified options and personalized results; (3) the present techniques may enable quick access to accounts and policies to execute changes and make updates with ease and efficiency; (4) customers may be allowed to review and make changes at the layer of detail that works best for them individually; (5) once changes are submitted, customers may receive confirmation and select their preferred channel at any time to complete the process; and/or other features, including those discussed elsewhere herein.

The present techniques may utilize a Smart Engine (SE), working in the background, that may use: (a) a minimum amount of information the customer needs to provide; (b) what may be already known about that customer, e.g., customer information (address, billing information, insured assets, family members, etc.); (c) what may be known about their environs; (d) related public information sources; (e) third party sources of information; and/or other information or sources of information.

A computer system may be used directly by customers via an online or mobile interface and/or may also be used by agents or contact center representatives via an interface which is appropriate for them. The smart engine, utilizing input from the customer (or agent or contact center representative on their behalf) in conjunction with stored data about the customer and their assets, may produce both a customized experience and personalized options and results for the customer's consideration.

The layered experience (presented via a computer application) may bring customers to the end result (e.g., insurance purchasing decision or policy change) as quickly as possible, via an “express lane,” and then lets them explore details and customize options if they desire. It is envisioned that a substantial amount of users will use this express lane and be satisfied with the information that they are given such that they do not feel the need to explore further. The remaining users may be able to explore to whatever level of detail that they desire via the computer application.

### I. EXEMPLARY INSURANCE QUOTE APPLICATION SYSTEM

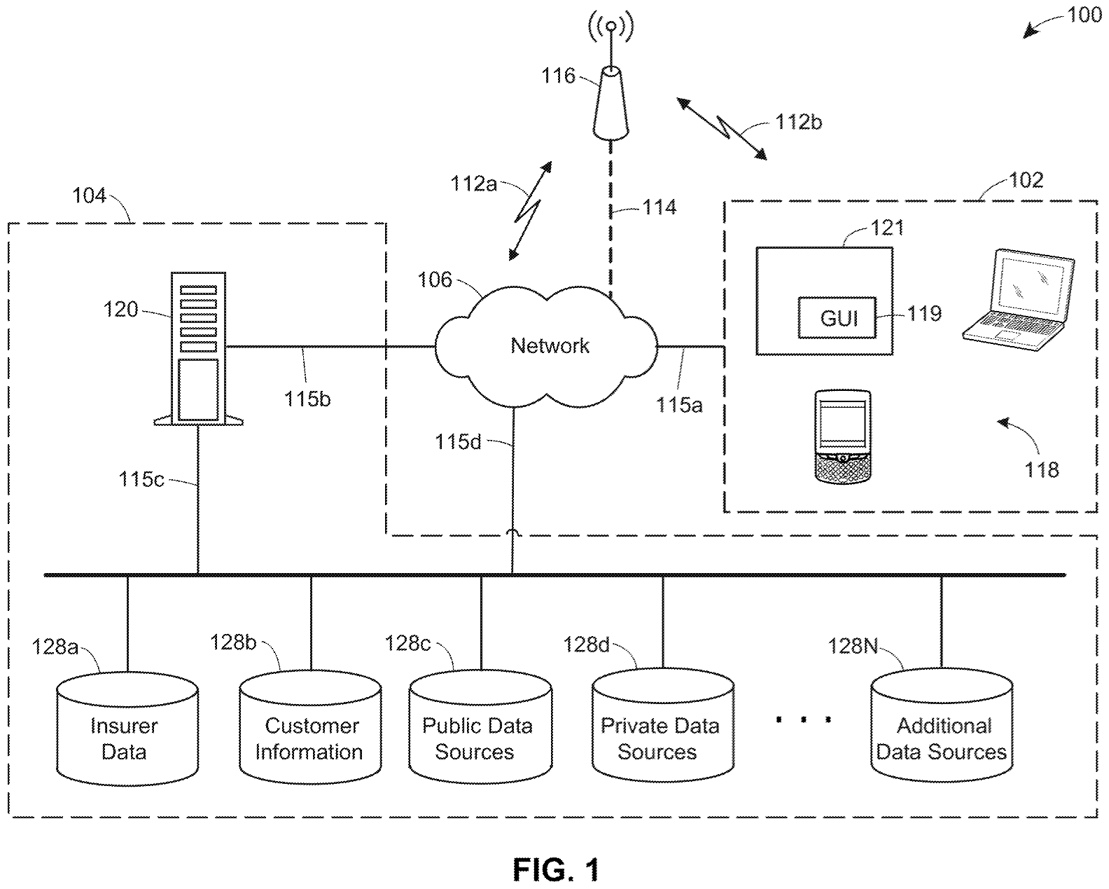

FIG. 1 illustrates a block diagram of an exemplary online application system 100 in accordance with one aspect of the present disclosure. Online application system 100 may include a front end 102, a data system 104, and/or a network 106. The system may include additional, fewer, or alternate components, including those discussed elsewhere herein.

Online application system 100 may facilitate the calculation of a quoted price and/or an approval for an applied-for product. In some aspects, the quoted price calculated may be an insurance policy quote requested from a user. In other aspects, the quoted price may be for any product that utilizes an aggregate collection of data to determine a price, such as any suitable product that is based upon risk-assessment, for example. Examples of aspects in which other products are quoted besides insurance products may include determining a finance rate based upon data such as an applicant's credit score and/or financial history. Examples of aspects in which applied-for products are approved may include the determination of whether to approve a customer for a loan at a particular finance rate. Although the following examples are discussed in terms of insurance product quotes, those of ordinary skill in the relevant art(s) will appreciate that these examples may be modified for any product that is applied through the collection of data via an application process.

Front end 102 may include one or more devices 118. A device 118 may include any suitable device that is configured to facilitate user interaction to exchange data with network 106. For example, device 118 may be a mobile device (e.g., smartphone, cell phone, tablet, netbook, phablet, smart glasses, smart contact lenses, electronic wearable devices, computer, personal desktop computer, laptop, pager, personal digital assistance, smart watch, portable computer, handheld computing device, and/or other computing device capable of wired or wireless communication). In various aspects, a device 118 may be implemented as any suitable device configured to display a graphical interface (GUI) 119 within a web browser 121 implemented as part of a web-based application to enable a user to interact with a respective device 118. Although FIG. 1 illustrates GUI 119 as part of web browser 121, those of ordinary skill in the relevant art(s) will appreciate that online application system 100 may implement any suitable platform without departing from the spirit and scope of the present disclosure. For example, GUI 119 may be implemented as one or more parts of a dedicated application in addition to, or as an alternative to, a web-based application.

In various aspects, computing device 118 may be configured to communicate with network 126 to receive data from and send data to data system 104 via network 106. Computing device 118 may be configured to receive data from data system 104 and to generate and/or display one or more prompts and/or options to a user via GUI 119 based upon the received data. Computing device 118 may be configured to send the user's answers and/or selected options to data system 104 and to receive data from data system 104 in response to this sent data. Computing device 118 may facilitate collecting information from a user and communicating with data system 104 to display one or more quotes for insurance products as requested by a user via GUI 119.

Network 106 may include any appropriate combination of wired and/or wireless communication networks. For example, network 106 may include any combination of a local area network (LAN), a metropolitan area network (MAN), a wide area network (WAN), and may facilitate a connection to the Internet. To provide further examples, network 106 may include wired telephone and cable hardware, satellite, cellular phone communication networks, etc.

In various aspects, any of front end 102 may communicate with network 106 via any suitable number of wired and/or wireless links. For example, front end 102 may communicate with network 106 wirelessly via a station 116. Station 116 may include, for example, any suitable number of cellular base stations, access points, local WAN access points, etc. In accordance with such aspects, front end 102 may be configured to communicate with network 106 via station 116 utilizing links 112a and 112b. In aspects in which front end 102 communicate with network 106 via a combination of wired and wireless links, front end 102 may communicate with station 116 via link 112b, which in turn may be coupled to network 106 via a wired link 114. In aspects in which front end 102 may communicate with network 106 via wired links, front end 102 may communicate directly with network 106 via wired link 115a without communicating with station 116. Although not illustrated in FIG. 1 for purposes of brevity, any communications between data system 104 and front end 102 may take place via any suitable combination of wired and/or wireless links between one another and/or any suitable number of networks, which may or may not include network 106.

Data system 104 may include one or more computing devices 120 and N number of databases 128a-N. In some aspects, computer device 120 may implement hardware and/or software components to facilitate communications with one or more databases 128a-128N via any suitable number of links 115c. In other aspects, computing device 120 may implement hardware and/or software components to facilitate communications with one or more databases 128a-128N via network 106, such as via links 115b and 115d, for example. Although additional wireless links are not shown in FIG. 1 for purposes of brevity, those of ordinary skill in the relevant art(s) will appreciate that computing device 120 may communicate with any of databases 128a-N using any combination of wired and/or wireless links. Furthermore, those of ordinary skill in the relevant art(s) will also appreciate that different types of networks and/or links may be implemented based upon the type of data that is accessed from a respective database 128a-N. For example, a private network and one or more secure links may be implemented to facilitate communications between computing device 120 and any of databases 128a-N (e.g., via link 115c) to enable computing device 120 to retrieve data of a sensitive, private, and/or proprietary nature. To provide another example, a link via the Internet may be implemented for communications between computing device 120 and any of databases 128a-N (e.g., via links 115c and 115d) to enable computing device 120 to retrieve data that is publicly available or not of a sensitive nature.

Although databases 128a-N are illustrated in FIG. 1 as separate from computing device 120, various aspects may include any suitable amount of data that is stored in any of databases 128a-N being additionally or alternatively stored in one or more storage components integrated as part of computing device 120.

In an aspect, each of databases 128a-N includes information that may supplement the information sent back to computing device 120 from a user via front end 102. Using an insurance application process as an example, databases 128a-N may include information that may be utilized for the calculation of an insurance premium quote requested by a user. For example, a user may wish to obtain a homeowners insurance quote, a car insurance quote, a life insurance quote, etc. As will be appreciated by those of ordinary skill in the relevant art(s), a particular insurance quote calculation requires information based upon a risk assessment in accordance with the respective type of insurance policy requested. For example, a car insurance quote may assess risk based upon factors such as the driver's age, driving record, previous convictions, marital status, where the vehicle is parked when not being driven, etc. To provide another example, a home owners insurance quote may assess risk based upon information such as the type of building to be insured, the construction materials, the building address, etc. To provide yet another example, a life insurance policy may assess risk based upon information such as the insured's age, previous medical history, pre-existing conditions, lifestyle, etc.

In accordance with various aspects, computing device 120 may facilitate the collection of information from a user and/or one or more of databases 128a-N to calculate an insurance quote and to send data to front end 102 to be displayed as an insurance quote to a user via browser 121. Because risk assessment information varies based upon the type of insurance policy, aspects may include computing device 120 determining the information that is needed to calculate a quote for a user based upon the user's policy request. Traditionally, this information may be obtained from the user by displaying one or more prompts via GUI 119 and collecting the user's answers to these prompts.

However, this may require a user to answer a burdensome number of prompts. Therefore, various aspects may include computing device 120 determining an amount of information that is needed to calculate an insurance quote, which may include the minimum amount of information needed to do so. Some portions of information required to calculate the respective insurance quote may be available via one or more of the databases 128a-N. Computing device 120 may retrieve portions of information from one or more of databases 128a-N instead of via a user's response to generated prompts. In other words, once computing device 120 retrieves the portions of information from one or more of databases 128a-N, the user does not need to answer prompts otherwise requesting this information, thereby decreasing the number of prompts that need to be answered.

In various aspects, computing device 120 may receive data from and send data to front end 102 such that an interactive application presented to the user via GUI 119 dynamically adjusts the prompts presented to the user based upon the user's answers. That is, one or more prompts presented to the user may result in one or more additional sub-prompts being generated for a respective prompt. These sub-prompts may be referred to as “layers” of prompts, and the user's interaction with GUI 119 to answer a combination of presented prompts and sub-prompts may be represented as a user experience path as the user navigates through the process of answering questions presented as a series of prompts and/or sub-prompts. As a result, the user experience path “length” is longer when the user answers more prompts and sub-prompts, and shorter when the user answers less prompts and sub-prompts.

For example, a request for a car insurance policy may result in GUI 119 displaying a prompt asking a user whether she was involved in an accident in the past five years. If so, then computing device 120 may cause GUI 119 to display sub-prompts requesting additional details from the user regarding any accidents. To provide another example, a user requesting a life insurance product may be presented with a number of prompts via GUI 119 to determine the best life insurance options for the user. Then, computing device 120 may cause GUI 119 to present these life insurance policy options to the user as a number of sub-prompts.

In some aspects, computing device 120 may send data to front end 104 such that one or more prompts and/or sub-prompts are eliminated by retrieving information from one or more of databases 128a-N that would ordinarily be entered by a customer via the user's answers to the one or more prompts and/or sub-prompts. In other aspects, computing device 120 may send data to front end 104 such that one or more prompts and/or sub-prompts are still presented to the user but the respective fields and/or options associated with the one or more prompts and/or sub-prompts may be prepopulated with information from one or more of databases 128a-N. In this way, online application system 100 may control a user's experience path length to save the user time when submitting information for an insurance premium quote.

Computing device 120 may make some assumptions about the user in doing so. For example, computing device 120 may eliminate one or more prompts and/or sub-prompts by assuming that a user wants to answer the least amount of prompts. This may include, for example, eliminating prompts associated with coverage amounts and simply presenting a premium quote that includes the state minimum coverage amounts. As a result of these assumptions, a tradeoff may be made between the amount of control a user has over the application process and the reduction in user's experience path length.

Therefore, various aspects may allow a user to select a control option based upon the amount of control the user desires to have over the application process. This control option may be any suitable prompt that enables a user to express this intention, such as a selection of a checkbox, radio button, drop down list, etc. If a user indicates that he would like the minimum amount of control, then computing device 120 may eliminate (or prepopulate) all prompts and/or sub-prompts for which answers may be obtained from one of more of databases 128a-N, thereby minimizing the user's experience path length. In contrast, if the user indicates she wants maximum control while navigating through the application, computing device 120 may not eliminate (or prepopulate) any prompts and/or sub-prompts for which answers may be obtained from one of more of databases 128a-N, thereby maximizing the user's experience path length. In addition, if a user indicates that she wants a level of control in between a maximum and minimum level, then computing device 120 may eliminate (or prepopulate) a portion of prompts and/or sub-prompts for which answers may be obtained from one of more of databases 128a-N, thereby providing the user with an experience path length between the maximum and the minimum length.

In accordance with various aspects, each of databases 128a-N may include different types of information that may be utilized to eliminate one or more generated prompts. Insurer database 128a, for example, may include information such as the insurer's insurance product offerings, information that is needed to calculate a quote for each insurance product, etc. In an aspect, computing device 120 may correlate the user's requested insurance product to a product in insurer product database 128a to determine the information needed to calculate the respective insurance product premium quote.

Additionally or alternatively, insurer database 128a may include proprietary information that has been collected by the insurer. Proprietary information may include any suitable data related to the user that may be collected and/or mined from one or more sources that may not otherwise be readily or conveniently available via public channels. This propriety information may include, for example, information gathered from third party sources via one or more contractual agreements that the insurer has made with third party data providers, such as demographic information regarding the user's age, location, and/or occupation. Examples of the types of proprietary data that may be stored in insurer database 128a may include information gathered from third party sources related to the user's driver's license suspensions, driving citations (e.g., moving violations) issued to the user, accident reports regarding details of accidents in which the user has been involved, the user's credit score history, vehicle event data recorder information, etc. Although some of this information may be publicly available, this information may not be easily obtained online and/or may need to be appropriately formatted for database storage. Therefore, examples of third party sources of such proprietary information may include any suitable source of census reports, crime reports, weather reports, vehicle history reports, etc.

Customer information database 128b may include, for example, information collected from the user across any line of insurer business and/or collected from the user via any insurer channel. This information may include, for example, data stored from previously calculated quotes and/or from previous interactions between the insurer and the user. For example, if a user currently has one type of insurance policy with the insurance provider, then customer information database 128b may include customer information associated with a customer profile. Because some of the information required for risk assessment of different types of insurance products may overlap, information stored in customer information database 128b may be retrieved and utilized to calculate other insurance product quotes when subsequently requested by the same user. Examples of the information stored in customer information database 128b may include names of the user's dependents, the user's home address, the user's date of birth, social security number, and/or driver's license number, user preferences such as previously submitted control options, preferred insurance policy delivery methods (e.g., paper versus electronic), a user's current location derived from the front end device 102 utilized by the user, genetic and/or medical history information, health screening results, etc.

Although illustrated as a single database for brevity, database 128c may represent one or more public data sources. Database 128c may include information about the user that is readily available via one or more public channels. Examples of public data source information may include a user's current address, current occupation, state coverage minimums, marital status, etc. Examples of the public data sources may include the United States Post Office (or other applicable post office of a respective country), city record data, and publicly available social networking data, such as data collected from a networking website such as LinkedIn.com, for example.

Although illustrated as a single database for brevity, database 128d may represent one or more private data sources. Database 128d may include information about the user that the user may not realize is accessible or otherwise applicable to insurance quotes, but nonetheless may be utilized for this purpose. Examples of private data source information may include unlisted phone numbers, the user's wedding date, the user having a child or an addition to his family (e.g., through adoption), the user's interests and/or hobbies, the user's online behavior, user account information such as credit card accounts, mortgages, financial institutions, etc. Examples of private data sources may include private social networking data (e.g., Facebook) and/or the user's browser history, for example. As will be appreciated by those of ordinary skill in the relevant art(s), to comply with state, local, and/or federal privacy regulations, the insurer may obtain the user's consent to access this information via one or more prompts generated via GUI 119.

In various aspects, computing device 120 may flag, label, and/or otherwise correlate each prompt generated via GUI 119 with one or more respective data types. For example, one or more prompts asking a user's marital status may be correlated to public data sources, while one or more prompts relating to a user's lifestyle may be correlated to private data sources. In this way, computing device 120 may attempt to retrieve information associated with one or more prompts from their associated data sources, thus eliminating the need for the user to answer these questions in accordance with the user's selected control option.

### II. EXEMPLARY SMART QUOTING ENGINE

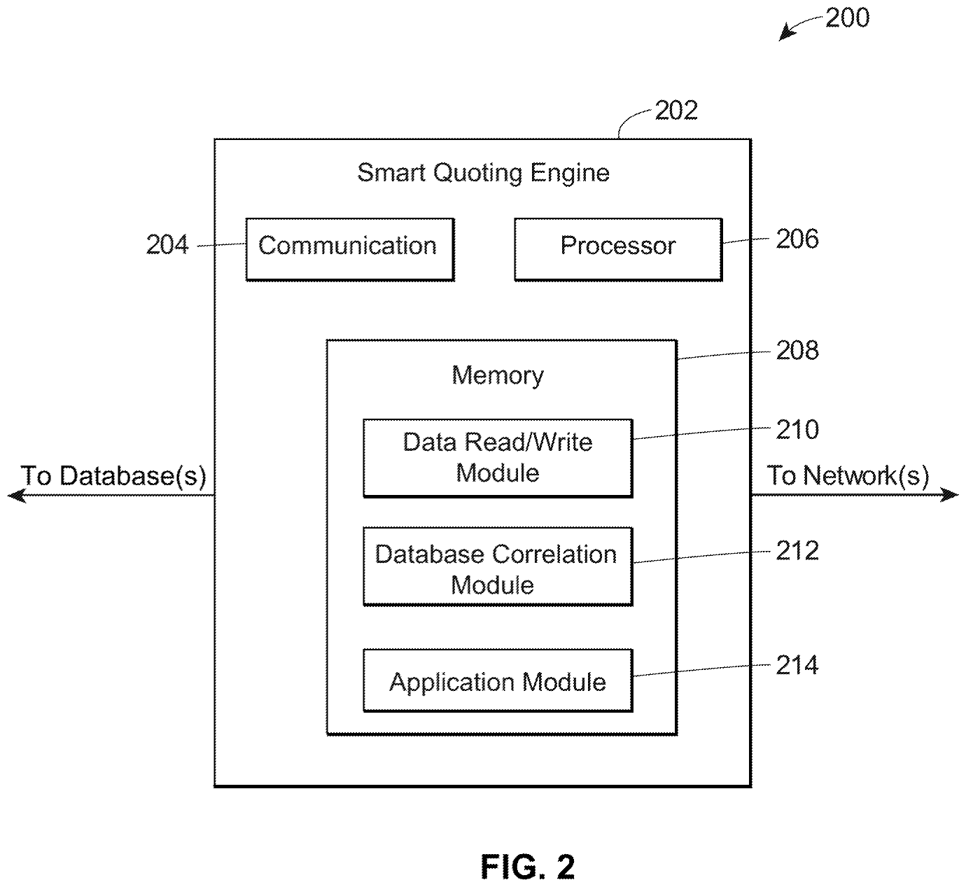

FIG. 2 illustrates a block diagram of an exemplary smart quoting engine 200 in accordance with an exemplary aspect of the present disclosure. Smart quoting engine 200 may include communication unit 204, processor 206, and/or memory 208. The engine may include additional, fewer, or alternate components, including those discussed elsewhere herein.

Smart quoting engine 202 may be implemented as any suitable computing or mobile device. In various aspects, smart quoting engine 202 is implemented within a server, a laptop computer, a tablet computer, a smartphone, etc. In various aspects, smart quoting engine 202 is implemented as one or more portions of computing device 120.

Communication unit 204 may be configured to facilitate data communications between smart quoting engine 202 and one or more databases and/or networks, such as one or more of databases 128a-N and/or network 106, as previously discussed with reference to FIG. 1, for example. Communication unit 204 may be configured to facilitate communications between one or more of databases 128a-N and/or network 106 in accordance with any suitable communication protocol or combination of protocols. In various aspects, communication unit 204 may be configured to utilize the same or different communication protocols to facilitate respective communications between one or more databases 128a-N and network 106. In an aspect, communication unit 204 may be configured to send data to a front end, such as front end 102, for example, as shown in FIG. 1. Communication unit 204 may send data in accordance with one or more applications executed on one or more devices that are part of the front end, such as devices 118, for example, as shown in FIG. 1. Communication unit 204 may send data that enables one of more devices 118 to display one or more prompts, options, and/or selections in accordance with such applications to a user. Communication unit 204 may be configured to receive data from one or more devices, such as devices 118, for example, as shown in FIG. 1. The data received from devices 118 may be processed by communication unit 204 and/or processor 206 and utilized to determine a number of prompts and/or sub-prompts to eliminate and/or to prepopulate and to calculate one or more requested insurance premium quotes requested by the user of the respective device 118.

As will be appreciated by those of ordinary skill in the relevant art(s), communication unit 204 may be implemented with any combination of suitable hardware and/or software to enable these functions. For example, communication unit 204 may be implemented with any number of wired and/or wireless transceivers, network interfaces, physical layers (PHY), etc. Communication unit 204 may optionally enable communications between smart quoting engine 202 and one or more additional networks, which may or may not be part of network 106. For example, communication unit 204 may be configured to communicate with cellular and/or WLAN networks in addition to network 106. Networks separate from network 106 are not shown in FIG. 1 for purposes of brevity.

Processor 206 may be configured to communicate with memory 208 to store to and read data from memory 208. In accordance with various aspects, memory 208 is a computer-readable non-transitory storage device that may include any combination of volatile (e.g., a random access memory (RAM)), or a non-volatile memory (e.g., battery-backed RAM, FLASH, etc.). Memory 208 may be configured to store instructions executable on processor 206. These instructions may include machine readable instructions that, when executed by processor 206, cause processor 206 to perform various acts. Data read/write module 210, data correlation module 212, and application module 214 are portions of memory 208 configured to store instructions executable by processor 206.

Data read/write module 210 may include instructions that, when executed by processor 206, causes processor 206 to read data from and/or to write data to one or more of databases 128a-N via communication unit 204. In an aspect, data read/write module 210 may enable processor 206 to query data from one or more of databases 128a-N and/or store this data in memory 208. Further in accordance with this aspect, data read/write module 210 may include instructions that enable processor 206 to access stored data from memory 208 when executing instructions from database correlation module 212 and/or application module 214. Additionally or alternatively, data read/write module 210 may include instructions that, when executed by processor 206, causes processor 206 to process data received from network 106 and/or to process data to be transmitted to network 106.

Application module 214 may be a portion of memory 208 configured to store instructions and/or algorithms that, when executed by processor 206, cause processor 206 to communicate with one or more front end devices to facilitate the calculation of an insurance product premium quote. For example, executable instructions stored in application module 214 may enable communications unit 204 to send data to one or more devices 118 that cause device 118 to display one or more options and/or prompts to be selected by a user. Executable instructions stored in application module 214 may enable communications unit 204 to receive a user's answer to one or more displayed options and/or prompts. Furthermore, executable instructions stored in application module 214 may enable processor 206 to process data to be sent and received via communications unit 204 to determine an insurance product premium quote requested by a user, determine a control option selected by the user, determine a number of prompts and/or sub-prompts to present, omit, or prepopulate based upon the user's selected control option, and to calculate an insurance premium quote based upon information collected from the user and/or information received from one or more of databases 128a-N in lieu of the prompts not presented to the user.

Database correlation module 212 may be a portion of memory 208 that may be configured to store instructions, that when executed by processor 206, cause processor 206 to determine which of databases 128a-N to access to retrieve information to calculate an insurance premium quote that is not otherwise obtained from the user. As will be appreciated by those of ordinary skill in the relevant art(s), database correlation module 212 may determine which of the databases 128a-N communication unit 204 should retrieve information using any suitable process. For example, application module 214 may cause processor 206 to process data to be sent to a device 118 via communications unit 204. In various aspects, this data may include any suitable type of tag and/or label that is associated with a type of data and/or one or more of databases 128a-N. If a control option selected by the user results in one or more prompts otherwise displayed being eliminated (or prepopulated), then database correlation module 212 may use the tags and/or labels to retrieve the information that would otherwise be received from the user's answer to the eliminated prompts from an appropriate database. The tags and/or labels may be of any suitable type of format to facilitate the matching and/or identification of the appropriate database. Examples of suitable tags and/or labels may include numeric indicators, text strings, binary strings, etc.

As will be appreciated by those of ordinary skill in the relevant art(s), although data read/write module 210, database correlation module 212, and application module 214 are illustrated as separate modules, any instructions included in each of the respective modules may be combined with other modules and/or may be stored in a memory that is separate from memory 202.

### III. OVERALL ILLUSTRATION OF EXEMPLARY USER EXPERIENCE PATHS WITHIN AN INSURANCE QUOTING APPLICATION

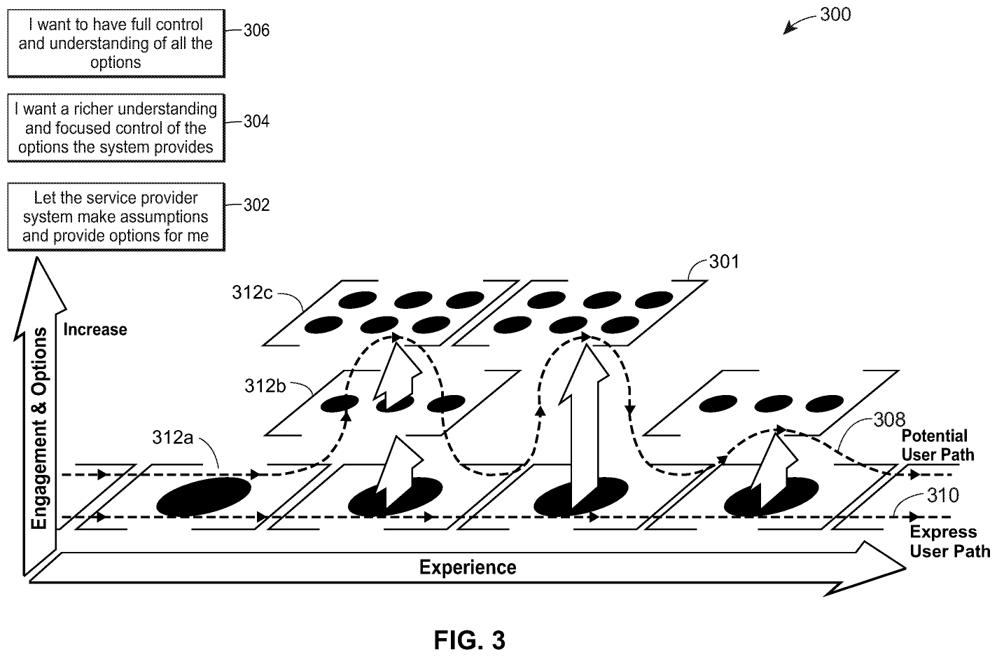

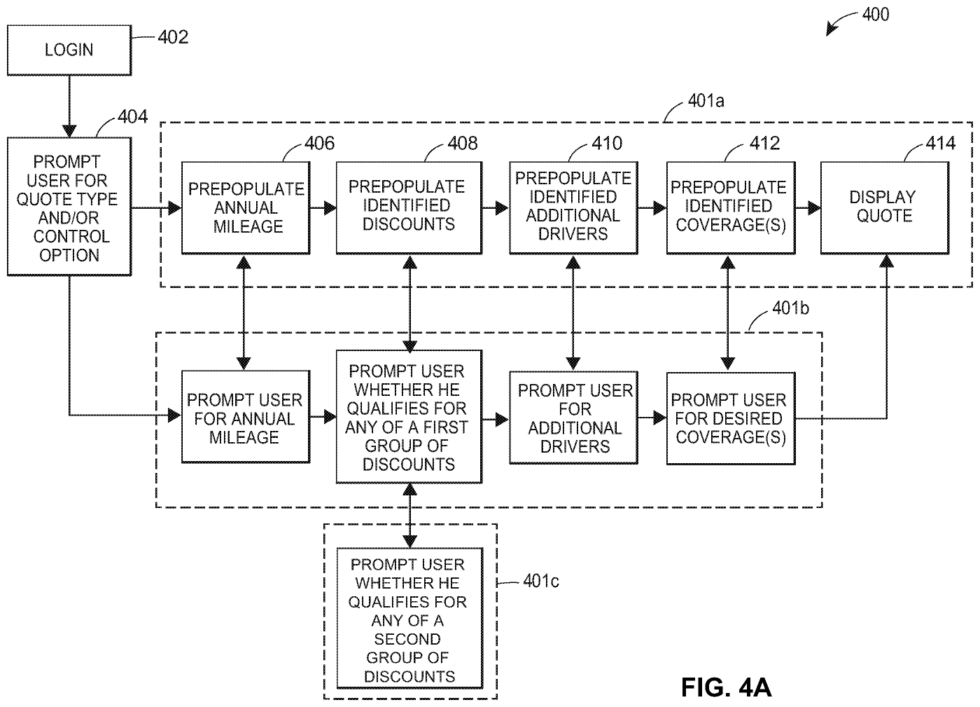

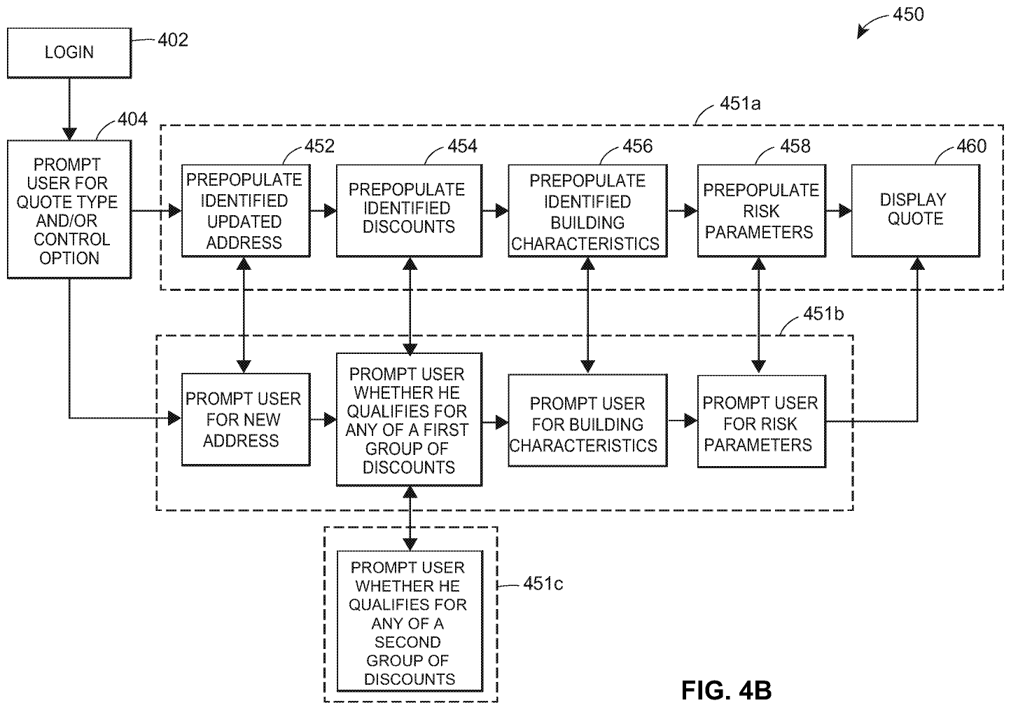

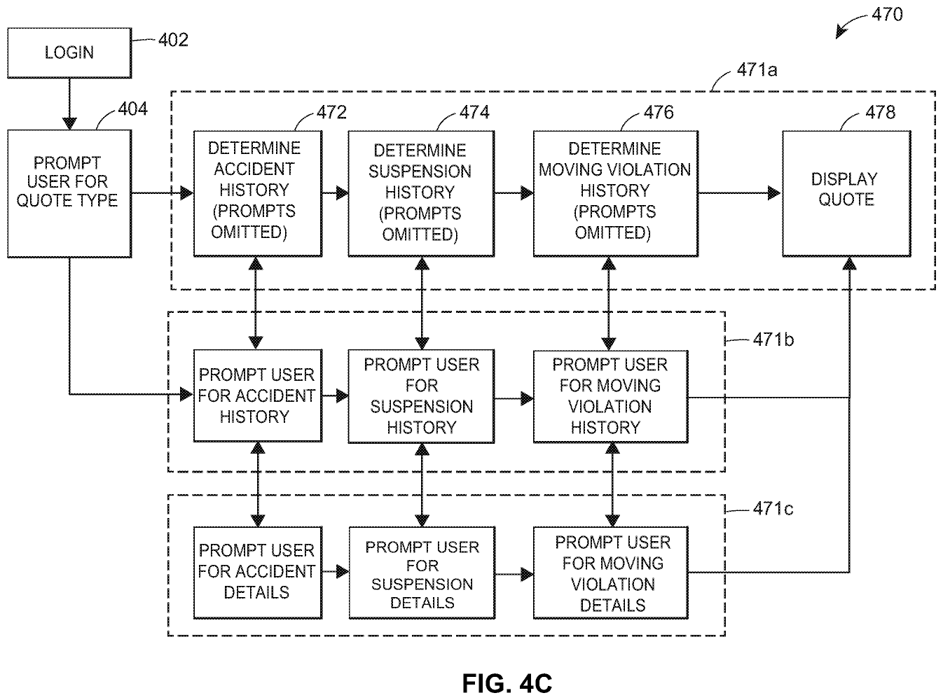

FIG. 3 illustrates a block diagram 300 of various exemplary user experience paths in accordance with an exemplary aspect of the present disclosure. As previously discussed, a user's interaction with an online application process may be associated with one of several user experience path lengths based upon the control options selected by a user. As shown in FIG. 3, in accordance with an aspect, three control options 302, 304, and 306 may be presented to a user, each providing a tradeoff between experience path lengths (i.e., a number of prompts answered by the user) and the control the user desires over the overall interactive experience (i.e., the amount of assumptions made by the application). Each control option may be associated with a respective layer. As shown in FIG. 3, control option 302 is associated with layer 312a, control option 304 is associated with layer 312b, and control option 306 is associated with layer 312c. Examples of the types of prompts and sub-prompts that may be displayed to a user along each of layers 312a-c are further discussed below with reference to FIGS. 4A-C and 5A-B.

Each of layers 312a-c, in turn, may include a number of prompts and/or sub-prompts that may be presented to a user. In an aspect, the prompts and/or sub-prompts may be presented to the user as a plurality of sequentially-presented interactive windows, with each window 301 shown in FIG. 3 as including a number of respective prompts and/or sub-prompts. As shown in FIG. 3, layer 312a may represent an express user experience path, or a number of sequentially-presented interactive windows each displaying prompts that are presented to a user while representing a minimum user experience path length. In accordance with an aspect, layer 312a corresponds to control option 302, whereby the user has requested that the insurer application make assumptions for the user. A user navigating the application by answering prompts displayed via sequentially-presented interactive windows associated with control option 302 would follow the user experience path 310. In an aspect, the selection of control option 302 may result in a user having to answer a minimal number of prompts such that only information that is unavailable via databases 128a-N is collected from the user via the user's response to the presented prompts along user experience 310.

Layer 312b represents an intermediate user experience path represented by a number of sequentially-presented interactive windows, some of which display basic prompts and some of which display sub-prompts of their respective basic prompts. In accordance with an aspect, layer 312b corresponds to control option 304, whereby the user has requested a richer understanding and focused control of the options the system provides. A user navigating the application by answering prompts displayed via sequentially-presented interactive windows associated with control option 304 would follow a user experience path including prompts and/or sub-prompts included in layers 312a and/or 312b.

Layer 312c represents a maximum user experience path represented by a number of sequentially-presented interactive windows, each of which display basic prompts and sub-prompts associated with their respective basic prompts. In accordance with an aspect, layer 312c corresponds to control option 306, whereby the user has requested to have full control and understanding of all options provided by the system. A user navigating the application by answering prompts displayed via sequentially-presented interactive windows associated with control option 306 would follow a user experience path 308 including prompts and/or sub-prompts included in each of layers 312a, 312b, and/or 312c.

### IV. ILLUSTRATIVE EXAMPLES OF USER EXPERIENCE PATHS WITHIN AN INSURANCE QUOTING APPLICATION

FIG. 4A illustrates a block diagram 400 of various exemplary user experience paths for obtaining an automotive insurance quote using prepopulated prompts in accordance with an exemplary aspect of the present disclosure. Block diagram 400 illustrates several user experience layers 401a-c that represent a user's interaction with an insurance quoting application according to an aspect. In accordance with an aspect, the prompts included in each of the user experience layers 401a-c are displayed on a suitable device, such as on a device 118 via GUI 119, for example, as shown in FIG. 1. The prompts and sub-prompts shown in FIG. 4 are shown for illustrative purposes, and the user experience layers 401a-c may include any number of prompts and/or sub-prompts based upon the relevant information that is needed to accurately calculate a respective insurance premium quote.

Each block component shown in FIGS. 4A-C may represent one or more sequentially-presented interactive windows or screens as part of a GUI, such as GUI 119, for example, as shown in FIG. 1. As will be appreciated by those of ordinary skill in the relevant art(s), the prompts and/or sub-prompts shown in FIGS. 4A-C may be included in any suitable number of component blocks. For example, prompts represented in two or more blocks may be combined in a single window. To provide another example, prompts presented in a single block may be separated into several windows. Furthermore, although not shown in FIGS. 4A-C, the user's answers or selections to prompts displayed at each window may be sent to another computing device, such as computing device 120, for example, as shown in FIG. 1. The next sequentially displayed window may then be determined, calculated, and data sent back to the relevant device from the computing device may cause the next sequential window being displayed to the user having the appropriate prompts displayed (or prepopulated) as indicated by the arrows in FIGS. 4A-C.

As shown in FIG. 4A-C, a user may first be presented with a login screen at window 402, where the user is prompted for a username, login name, password, etc., to gain access to the user's insurance profile. In an aspect, a computing device, such as computing device 120, for example, that is executing the quoting application may correlate the user's profile to previously saved quotes, customer information stored in an appropriate database (e.g., customer information database 128b). Once the user has logged into the insurer application system, then the user may be presented with another window 404.

As shown in FIG. 4A-C, at window 404 the user may be presented with one or more options such as a type of insurance product to be selected and one or more control options. In the example shown in FIGS. 4A and 4C, the user has selected a car insurance quote. In the example shown in FIG. 4B, the user has selected a homeowners insurance quote. Once the user makes this selection and indicates a desired control option, the user may submit this information to a computing device executing the application.

As shown in FIG. 4A, then, the user may be presented with a number of prompts in window 406. In some aspects, prompts may be omitted completely based upon the user's control option selection, in which case window 406 may be omitted. In other aspects, the windows including the relevant prompts may be presented to the user but do not require the user to provide an answer to the prompts. In other words, the prompts may be presented that have one or more options, selections, and/or text entries that are preselected, prefilled, and/or prepopulated. FIGS. 4A-B show examples of aspects utilizing prepopulation techniques, while FIG. 4C shows an example of an aspect utilizing a prompt omission technique.

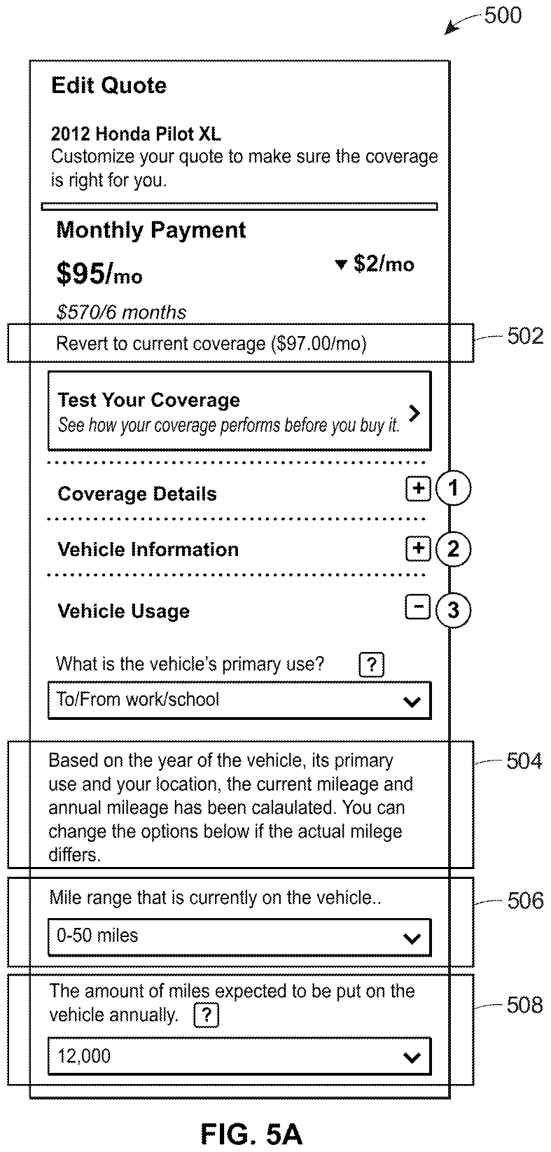

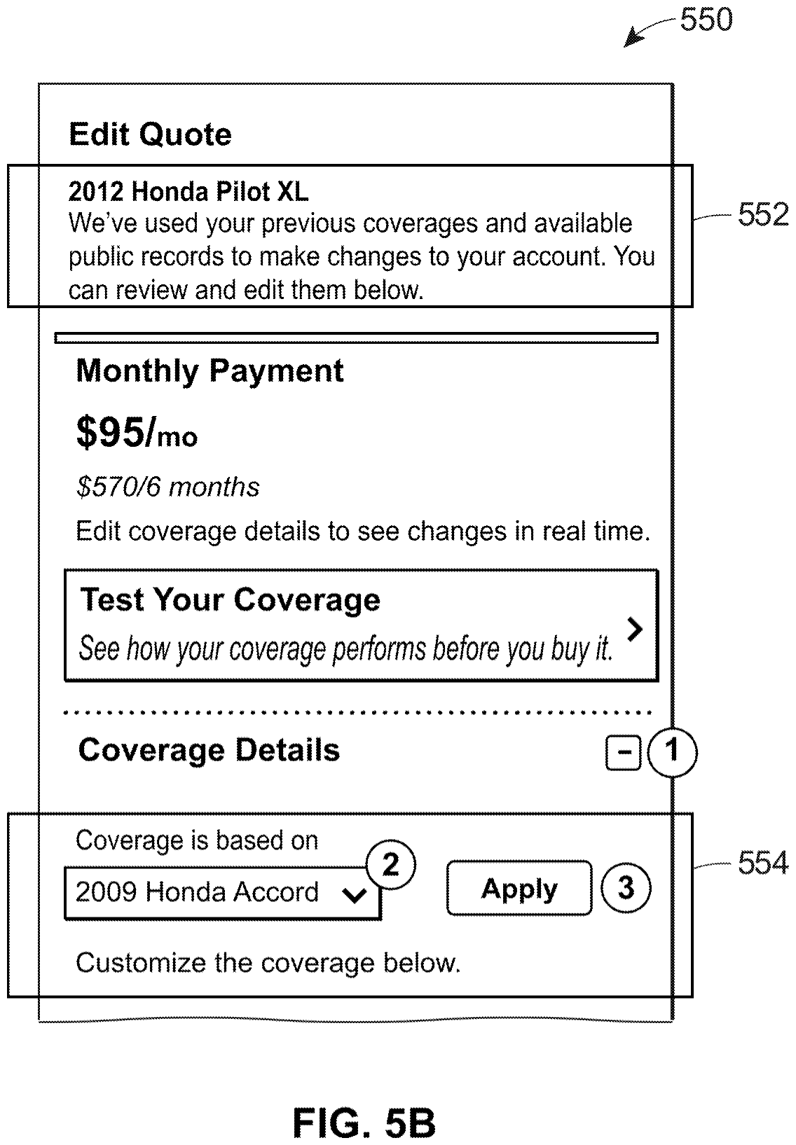

Although the block diagrams shown in FIGS. 4A-B use these prepopulation techniques, each of the displayed windows may be interactive and allow a user to adjust, modify, or otherwise alter the prepopulated information for better control and accuracy if the user so desires, as will be further explained with reference to FIGS. 5A-B below. In this way, prepopulation aspects provide a good balance between reducing the input required from a user while allowing the user to maintain more control over the application process by viewing the assumed information based upon the user's control option.

As shown in FIG. 4A, window 406 may include prompts such as an annual mileage that a driver intends to drive the vehicle for which an insurance quote is sought. If the user has selected a control option that allows the application to make assumptions for the user, such as control option 302, for example, as shown in FIG. 3, then window 406 may include the annual mileage prompt having a prepopulated number. Alternatively, if the user selected another control option, such as control options 304 or 306, for example, as shown in FIG. 3, then the annual mileage may not be prepopulated and would require an answer to be entered by the user. In this way, the user navigates through prompts presented and/or prepopulated while navigating through the various layers 401a-c based upon the user's desired control option.

The prepopulated annual mileage number may be calculated based upon various types of data retrieved from any suitable number of databases 128a-N, as previously discussed with respect to FIG. 1. For example, computing device 120 may determine the user's home address and place of employment from insurer database 128a and/or customer information database 128b and use this information to estimate an annual mileage based upon the assumption that the user would be driving between his home address and his place of employment. To provide another example, if database 128a and/or 128b indicated that the user was self-employed and worked at home, then the appropriate mileage estimate may reflect a less than average annual mileage based upon this determination.

Once the user has selected and/or configured the annual mileage, the user may be presented with one or more prompts in window 408. Window 408 may include a number of prompts to determine whether a user qualifies for one or more discounts. If the user has selected a control option that allows the application to make assumptions for the user, such as control option 302, for example, as shown in FIG. 3, then window 408 may include these qualifying discount prompts being prepopulated and presented to the user. Alternatively, if the user selected another control option, such as control option 304, for example, as shown in FIG. 3, then one or more types of discount qualification prompts may be presented to the user in layer 401b while some other discount qualifications may be prepopulated as part of layer 401a.

For example, prompts included in layer 401b may include questions such as whether the user qualifies for veteran and/or military service discounts, while prepopulated discount prompts in layer 401a may be related to qualified discounts identified from the user's insurance profile for other insurance products. In other words, control option 304 may result in the application retrieving some information from a relevant database (e.g., insurer database 128a) while allowing a customer to specify additional information by not prepopulating all discount qualification prompts.

Furthermore, if the user selected another control option, such as control option 306, for example, as shown in FIG. 3, then none of the discount qualification prompts may be prepopulated. This allows the user to select and/or answer all discount relevant prompts presented to the user as part of layer 401c, and the application may not retrieve information from any of the relevant databases. Once the user submits and/or confirms the discount qualification information, then the user may be presented with one or more prompts in window 410.

Window 410 may include a number of prompts to determine whether a user desired to insure additional drivers. If the user has selected a control option that allows the application to make assumptions for the user, such as control option 302, for example, as shown in FIG. 3, then window 410 may include these additional drivers being prepopulated. Alternatively, if the user selected another control option, such as control options 304 or 306, for example, as shown in FIG. 3, then the additional driver prompts may not be prepopulated. This allows the user to select and/or answer additional driver prompts presented to the user as part of layer 401b, and the application may not retrieve information from any of the relevant databases in accordance with these prompts.

The additional drivers may be determined based upon various types of data retrieved from any suitable number of databases 128a-N, as previously discussed with respect to FIG. 1. For example, computing device 120 may determine the user's dependents and their respective ages from customer information database 128b, and use this information to assume that the user may wish to insure these additional dependents who are of the appropriate driving age. To provide another example, if a private source database 128d indicated that the user recently adopted a child who was of the appropriate driving age, then this information may be used to prepopulate the additional drivers list with the adopted child. Once the user submits and/or confirms any additional drivers to be insured, then the user may be presented with one or more prompts as part of window 412.

Window 412 may include one or more prompts to determine a user's desired amount of coverage for various aspects of the insurance quote, such as bodily injury, property damage, etc. If the user has selected a control option that allows the application to make assumptions for the user, such as control option 302, for example, as shown in FIG. 3, then window 412 may include the coverage amounts being prepopulated. Alternatively, if the user selected another control option, such as control options 304 or 306, as shown in FIG. 3, then one or more of the coverage amount prompts may not be prepopulated. This allows the user to select and/or answer additional coverage amount prompts presented to the user as part of layer 401b, and the application may not retrieve information from any of the relevant databases in accordance with these prompts.

The coverage amounts may be determined based upon various types of data retrieved from any suitable number of databases 128a-N, as previously discussed with respect to FIG. 1. For example, computing device 120 may determine the state minimum requirements from public database 128c, and use this information to assume that the user may wish to obtain at least this amount of minimum coverage. To provide another example, if insurer database 128a indicated that the user has another insured vehicle policy, then the coverage amounts associated with this policy may be used to prepopulate the coverage amount prompts with the same coverage from the other policy.

Assuming that the computing device has obtained all necessary information from the user once the coverage amounts are submitted and/or confirmed, the user may be presented with another window 414 that indicates the calculated premium amount.

FIG. 4B illustrates a block diagram 450 of various exemplary user experience paths for obtaining a homeowners insurance quote using prepopulated prompts in accordance with an exemplary aspect of the present disclosure. Similar to block diagram 400, block diagram 450 illustrates several user experience layers 451a-c that represent a user's interaction with an application according to an aspect.

As shown in FIG. 4B, window 452 may include prompts such as an updated or new address of the dwelling for which an insurance quote is sought. If the user has selected a control option that allows the application to make assumptions for the user, such as control option 302, for example, as shown in FIG. 3, then window 452 may include the updated dwelling address prompts having prepopulated fields. Alternatively, if the user selected another control option, such as control options 304 or 306, for example, as shown in FIG. 3, then the updated dwelling address prompts would not be prepopulated. In this way, similar to block diagram 400 shown in FIG. 4A, the user navigates through the various layers 451a-c based upon the user's desired control option.

The prepopulated updated dwelling address prompts may be determined using various types of data retrieved from any suitable number of databases 128a-N, as previously discussed with respect to FIG. 1. Additionally or alternatively, the updated dwelling address may be determined from a location of the device used by the user, such as a global positioning system (GPS), for example, that may be integrated as part of the device. For instance, computing device 120 may determine that the user's home address has recently changed from public database 128c, and use this to assume that the most recent address is the same as the dwelling address sought to be insured by the user. To provide another example, the GPS data may be used to reverse geocode the GPS coordinates to determine a reverse geocoded address, and assume that this reverse geocoded address is the same as the dwelling address sought to be insured by the user.

Once the user has selected and/or configured the updated address, the user may be presented with one or more prompts in window 454. Window 454 may include a number of prompts to determine whether a user qualifies for one or more discounts. If the user has selected a control option that allows the application to make assumptions for the user, such as control option 302, as shown in FIG. 3, for example, then window 454 may include qualifying discount prompts having prepopulated fields. Alternatively, if the user selected another control option, such as control option 304, for example, as shown in FIG. 3, then one or more types of discount qualification prompts may be presented to the user in layer 451b while some other discount qualification prompts may be prepopulated as part of layer 451a.

For example, prompts included in layer 451b may include questions such as whether the age of the property qualifies for one or more homeowner's insurance discounts, while prepopulated discount prompts in layer 401a may be related to qualified discounts identified from the user's insurance profile for other insurance products. In other words, control option 304 may result in the application retrieving some information from a relevant database (e.g., insurer database 128a) while allowing a customer to specify additional information by not prepopulating all discount qualification prompts.

Furthermore, if the user selected another control option, such as control option 306, as shown in FIG. 3, for example, then none of the discount qualification prompts may be prepopulated. This allows the user to select and/or answer all discount relevant prompts presented to the user as part of layer 451c, and the application may not retrieve information from any of the relevant databases. Once the user submits and/or confirms the discount qualification information, then the user may be presented with one or more prompts in window 456.

Window 456 may include a number of prompts to determine one or more building characteristics of the dwelling, such as building materials, for example. If the user has selected a control option that allows the application to make assumptions for the user, such as control option 302, for example, as shown in FIG. 3, then window 456 may include these additional building characteristic prompts having prepopulated fields. Alternatively, if the user selected another control option, such as control options 304 or 306, for example, as shown in FIG. 3, the additional building characteristic prompts may be presented to the user in layer 451b while some other building characteristic prompts may be prepopulated as part of layer 451a.

The building characteristics may be determined based upon various types of data retrieved from any suitable number of databases 128a-N, as previously discussed with respect to FIG. 1. For example, computing device 120 may determine the building characteristics from public database 128c, and use this information to determine whether one or more building characteristics may be relevant in the calculation of the homeowner's insurance quote. Once the user submits and/or confirms any additional building characteristics, then the user may be presented with one or more prompts as part of window 458.

Window 458 may include one or more prompts to determine one or more risk parameters, such as proximity of the dwelling to a fire department, whether the dwelling has a sprinkler system, proximity to a water source, whether the dwelling has a security system, etc. If the user has selected a control option that allows the application to make assumptions for the user, such as control option 302, for example, as shown in FIG. 3, then window 458 may include the risk parameter prompts having prepopulated fields. Alternatively, if the user selected another control option, such as control options 304 or 306, for example, as shown in FIG. 3, then one or more of the risk parameter prompts may be presented to the user in layer 451b while some other risk parameter prompts may be prepopulated as part of layer 451a.

The risk parameters may be determined based upon various types of data retrieved from any suitable number of databases 128a-N, as previously discussed with respect to FIG. 1. For example, computing device 120 may determine the risk parameters from public database 128c, and use this information to determine the appropriate risk parameters. To provide another example, if private database 128d indicated that the user's browsing habits were indicative of having security systems being quoted for the dwelling, then this information may be used to prepopulate a risk parameter prompt corresponding to the installation of a security system.

Assuming that the computing device has obtained all necessary information from the user once the coverage amounts are submitted and/or confirmed, the user may be presented with another window 460 that indicates the calculated premium amount.

FIG. 4C illustrates a block diagram 470 of various exemplary user experience paths for obtaining an automotive insurance quote by omitting prompts in accordance with an exemplary aspect of the present disclosure.

As shown in FIG. 4C, window 472 may include prompts asking a user whether the user has been recently involved in an accident (e.g., in the last five years). If the user has selected a control option that allows the application to make assumptions for the user, such as control option 302, for example, as shown in FIG. 3, then window 472 may be omitted, in which case the user may be presented with window 474 in one of layers 471b-c.

The user's answer to whether she has been in an accident may instead be determined using various types of data retrieved from any suitable number of databases 128a-N, as previously discussed with respect to FIG. 1. For example, computing device 120 may determine the user's accident records from insurer database 128a and/or public database 128c, and use this information to calculate the insurance quote instead of asking the user through the generation of window 472 in layer 471b.

Alternatively, if the user selected another control option, such as control option 304, for example, as shown in FIG. 3, then the user may be presented with window 472 in layer 471b, in which case the user would respond to prompts regarding the question of whether the user had an accident within a specific time period. Using the example control option 304, additional details about when the accident occurred that would be presented to the user as one or more sub-prompts in window 472 in layer 471c, such as whether a judgment was entered against the user, whether the accident was the user's fault, etc., may be determined using various types of data retrieved from any suitable number of databases 128a-N, as previously discussed with respect to FIG. 1.

For example, computing device 120 may determine information regarding the accident details from insurer database 128a and/or public database 128c, and use this information to calculate the insurance quote instead of asking the user through the generation of window 472 in layer 471c. However, is a user selected a control option that did not allow assumptions to be made for the user, such as control option 306, for example, as shown in FIG. 3, then the user would be presented with prompts regarding the details of accident in window 472 in each of layers 471b and 471c. Once the user submits and/or confirms any accident details, then the user may be presented with one or more prompts as part of window 474.

Window 474 may include prompts asking a user whether his license has recently (e.g., in the last five years) been suspended and/or revoked. If the user has selected a control option that allows the application to make assumptions for the user, such as control option 302, for example, as shown in FIG. 3, then window 474 may be omitted, in which case the user may be presented with window 476 in one of layers 471b-c.

The user's answer to whether his license has been suspended and/or revoked may instead be determined using various types of data retrieved from any suitable number of databases 128a-N, as previously discussed with respect to FIG. 1. For example, computing device 120 may determine the user's accident records from insurer database 128a and/or public database 128c, and use this information to calculate the insurance quote instead of asking the user through the generation of window 474 in layer 471b.

Alternatively, if the user selected another control option, such as control option 304, for example, as shown in FIG. 3, then the user may be presented with window 474 in layer 471b, in which case the user would respond to prompts regarding the question of whether the user's license had been suspended and/or revoked within a specific time period. Using the example control option 304, additional details about when the accident occurred that would be presented to the user as one or more sub-prompts in window 474 in layer 471c, such as the reasons for the suspension, a period of time the license was suspended, etc., may be determined using various types of data retrieved from any suitable number of databases 128a-N, as previously discussed with respect to FIG. 1.

For example, computing device 120 may determine information regarding the accident details from insurer database 128a and/or public database 128c, and use this information to calculate the insurance quote instead of asking the user through the generation of window 472 in layer 471c. However, if a user selected a control option that did not allow assumptions to be made for the user, such as control option 306, for example, as shown in FIG. 3, then the user would be presented with prompts regarding the details of the license suspension/revocation in window 474 in each of layers 471b and 471c. Once the user submits and/or confirms any suspension/revocation details, then the user may be presented with one or more prompts as part of window 476.

Window 476 may include prompts asking a user whether he has received one or more moving violations recently (e.g., in the last five years). If the user has selected a control option that allows the application to make assumptions for the user, such as control option 302, for example, as shown in FIG. 3, then window 476 may be omitted, in which case the user may be presented with window 478 to receive his quote.

The user's answer to whether he has received one or more moving violations may instead be determined using various types of data retrieved from any suitable number of databases 128a-N, as previously discussed with respect to FIG. 1. For example, computing device 120 may determine the user's citation records from insurer database 128a and/or public database 128c, and use this information to calculate the insurance quote instead of asking the user through the generation of window 476 in layer 471b.

Alternatively, if the user selected another control option, such as control option 304, for example, as shown in FIG. 3, then the user may be presented with window 476 in layer 471b, in which case the user would respond to prompts regarding the question of whether the user received one or more moving violations within a specific time period. Using the example control option 304, additional details about the moving violations that would be presented to the user as one or more sub-prompts in window 474 in layer 471c, such as the type of moving violations, details regarding the user's excess speed, etc., may be determined using various types of data retrieved from any suitable number of databases 128a-N, as previously discussed with respect to FIG. 1.

For example, computing device 120 may determine information regarding the moving violation details from insurer database 128a and/or public database 128c, and use this information to calculate the insurance quote instead of asking the user through the generation of window 472 in layer 471c. However, if a user selected a control option that did not allow assumptions to be made for the user, such as control option 306, for example, as shown in FIG. 3, then the user would be presented with prompts regarding the details of the moving violations in window 476 in each of layers 471b and 471c. Once the user submits and/or confirms any suspension/revocation details, then the user may be presented with a quote in window 478.

Assuming that the computing device has obtained all necessary information from the user once the coverage amounts are submitted and/or confirmed, the user may be presented with another window 478 that indicates the calculated premium amount.

### V. EXEMPLARY SCREENSHOTS OF AN INSURANCE QUOTING APPLICATION

FIG. 5A is an exemplary screenshot 500 of an application window having one or more prepopulated fields in accordance with an aspect of the present disclosure. In an aspect, screenshot 500 is an example of one or more prompts displayed in a window presented to the user in accordance with an insurance quoting application, such as one of the windows discussed with reference to FIGS. 4A-B, for example. Screenshot 500 may be an example of one of several sequentially-generated windows that may be displayed on a device GUI, such as GUI 119, for example, as shown in FIG. 1.

As shown in FIG. 5A, several portions of screenshot 500 include prompts that have been prepopulated. For example, portion 506 includes a prompt field requesting a mile range that is currently on the vehicle to be insured, while portion 508 includes a prompt field requesting the annual mileage that is expected to be put on the vehicle. Based upon the user's previous control option selection, these prompt fields may be prepopulated. The example shown in FIG. 5A is an example of a screenshot 500 in which a user selected a control option allowing the application to access various databases to ascertain the information displayed in the prompt fields. As shown in FIG. 5, portion 504 includes text notifying a user that the current mileage on the vehicle and the annual mileage have been calculated for the user. The user may alter these values or leave the values as is, depending on their accuracy.

Furthermore, portion 502 may include instructions notifying the user to revert to her current coverage. In other words, if the user already has insurance on an older car with the insurer and purchases a new car, this selection may migrate or move the previous coverage information over to the new vehicle. The coverage information that is migrated may include coverage amounts, deductibles, or any other suitable information relevant to the calculation of a new insurance premium quote. This data migration may be performed, for example, via computing device 120 retrieving this information from insurer database 128a. In this way, the data that needs to be manually input by a user is decreased through the use of supplemental data.

FIG. 5B is an exemplary screenshot 550 of an application window having one or more prepopulated fields in accordance with an aspect of the present disclosure. In an aspect, screenshot 550 is an example of one or more prompts displayed in a window presented to the user in accordance with an insurance quoting application, such as one of the windows discussed with reference to FIGS. 4A-B, for example. Screenshot 550 may be an example of one of several sequentially-generated windows that may be displayed on a device GUI, such as GUI 119, for example, as shown in FIG. 1.

As shown in FIG. 5B, several portions of screenshot 550 include prompts that have been prepopulated. For example, portion 554 may include a prompt field requesting a car from which to base the current insurance premium quote. Based upon the user's previous control option selection, the prompt field in portion 554 may be prepopulated to base new coverage options on a previous (or current) insurance policy coverage for another vehicle, in this case a 2009 Honda Accord. Portion 554 allows a user to change this selection, for example, if there are other insurance policies that the user wants to associate the coverage instead of the 2009 Honda Accord.

### VI. EXEMPLARY METHODS OF AN INSURANCE QUOTING APPLICATION

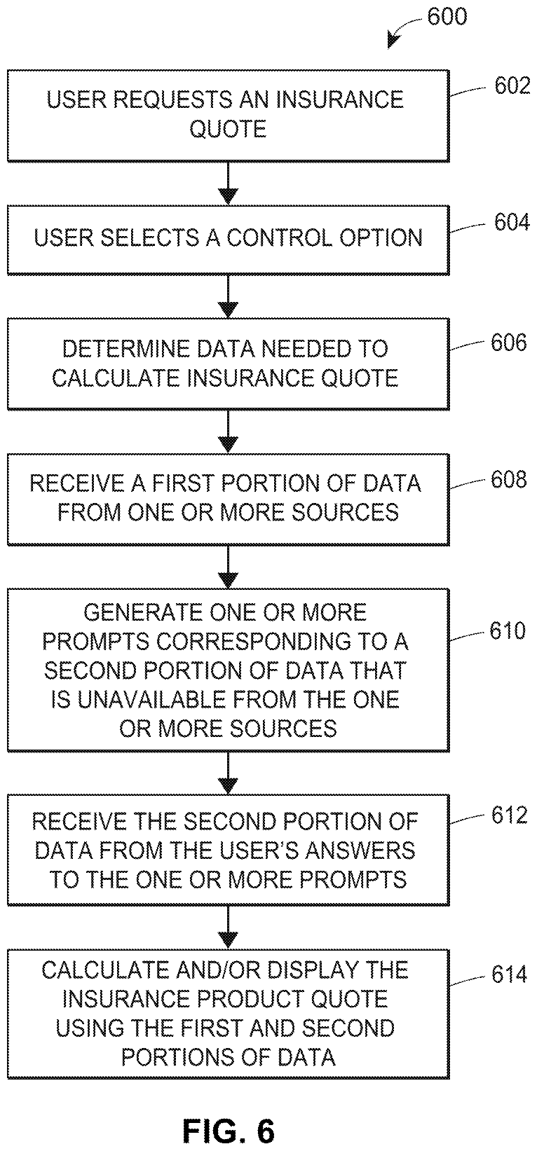

FIG. 6 illustrates an example method 600 in accordance with an exemplary aspect of the present disclosure. In the present aspects, method 600 is implemented as a part of an exemplary online application system 100, as shown in FIG. 1 and/or by a smart quoting engine, such as smart quoting engine 202, for example, as shown in FIG. 2.

Method 600 may begin when a user requests an insurance quote (block 602). This request may be made, for example, via a suitable GUI running on a suitable device, such as GUI 119 running on device 118, for example, as shown in FIG. 1. In an aspect, method 600 may include the user selecting a type of insurance quote and submitting this request to another computing device, such as computing device 120, for example, as shown in FIG. 1 and/or smart quoting engine 202, for example, as shown in FIG. 2 (block 602).

Method 600 may include a user indicating a control option (block 604). Again, this indication may be made, for example, via a suitable GUI running on a suitable device, such as GUI 119 running on device 118, as shown in FIG. 1. In an aspect, method 600 may include the user selecting one of several control options, for example, and submitting this request to another computing device, such as computing device 120, for example, as shown in FIG. 1 and/or smart quoting engine 202, for example, as shown in FIG. 2 (block 604). These control options may include, for example, control options 302, 304, and 306, as previously discussed with reference to FIG. 3. In some aspects, a computing device and/or smart quoting engine may assume a default control option selection for the user, and thus method 600 may not include the user selecting a control option in such cases.

Method 600 may include one or more processors determining data needed to calculate an insurance quote (block 606), which may be based upon the type of insurance quote selected (block 602) and the control option selected by the user (block 604). In an aspect, method 600 may include determining the minimum data needed to calculate an insurance quote (block 606). These one or more processors may include a CPU, such as processor 206, for example, as shown in FIG. 2, which may receive the insurance quote type (block 602) and control option (block 604) in conjunction with a communication unit, such as communication unit 204, for example. The data needed to calculate an insurance quote may be determined, for example, in accordance with one or more applications, algorithms, and/or modules, such as application module 214, for example, as shown in FIG. 2.

Method 600 may include one or more processors receiving a first portion of data from one or more sources (block 608) based upon the data needed to determine the insurance quote (block 606) and the selected control option (block 604). Again, the one or more processors may include a CPU, such as processor 206, for example, as shown in FIG. 2, which may receive the first portion of data in conjunction with a communication unit, such as communication unit 204, for example. Method 600 may include receiving the first portion of data may be from one or more databases based upon the type of data (block 608). The appropriate database from which to retrieve the first portion of data may be determined, for example, in accordance with one or more applications, algorithms, and/or modules, such as database correlation module 212, for example, as shown in FIG. 2. For example, the first portion of data may be retrieved from one or more databases, such as databases 128a-N, as shown in FIG. 1 (block 608).

Method 600 may include one or more processors generating one or more prompts (block 610) corresponding to a second portion of data that is unavailable from the one or more sources (block 608) utilized to receive the first portion of data. The one or more processors may include a CPU, such as processor 206, for example, as shown in FIG. 2, which may generate the one or more prompts as data sent to another suitable device, such as device 118, for example, as shown in FIG. 1. Method 600 may include sending data to be displayed as one or more prepopulated prompts (block 610) within a GUI based upon data retrieved from one or more databases (block 608) and the user's selected control option (block 604).

Method 600 may include one or more processors receiving a second portion of data (block 612) from the user's answers to the one or more generated prompts (block 610). Again, the one or more processors may include a CPU, such as processor 206, for example, as shown in FIG. 2, which may receive the second portion of data in conjunction with a communication unit, such as communication unit 204, for example.

Method 600 may include one or more processors calculating an insurance quote (block 614) based upon the selected type of quote requested by the user (block 602). Again, the one or more processors may include a CPU, such as processor 206, for example, as shown in FIG. 2, which may send the calculated insurance quote to a device in conjunction with a communication unit, such as communication unit 204, for example. Method 600 may include displaying the calculated insurance quote on a suitable device (block 614).

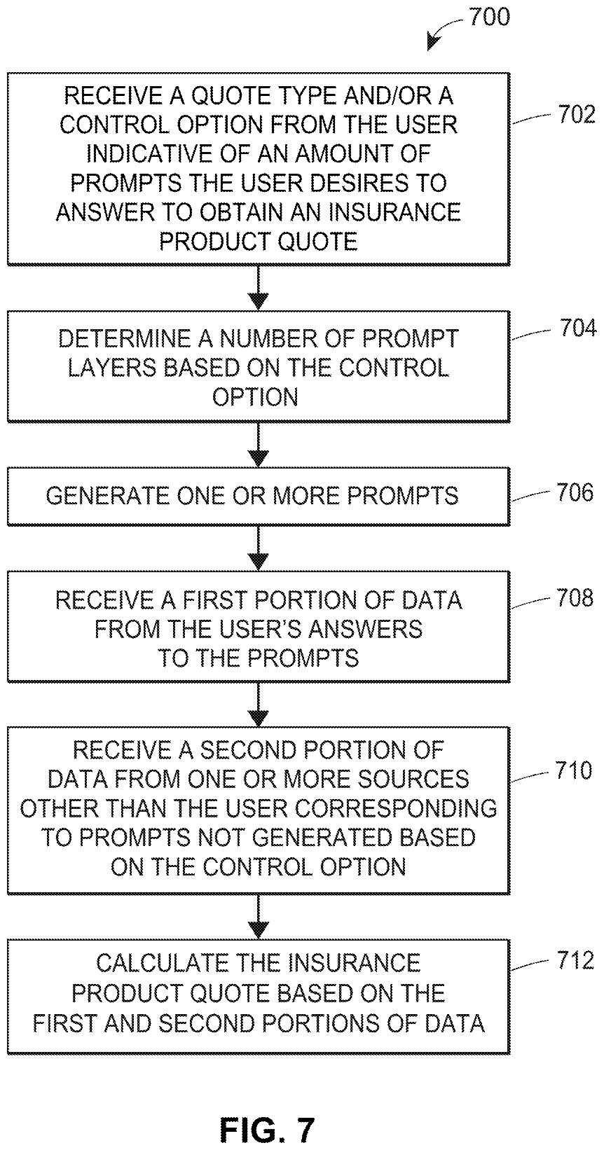

FIG. 7 illustrates an example method 700 in accordance with an exemplary aspect of the present disclosure. In the present aspects, method 700 may be implemented as a part of an exemplary online application system 100, as shown in FIG. 1 and/or by a smart quoting engine, such as smart quoting engine 202, for example, as shown in FIG. 2.

Method 700 may start when one or more processors receive a selected insurance quote type and/or a control option (block 702). These one or more processors may include a CPU, such as processor 206, for example, as shown in FIG. 2, which may receive the insurance quote type and control option (block 702) in conjunction with a communication unit, such as communication unit 204, for example. These selections may be made, for example, via a suitable GUI running on a suitable device, such as GUI 119 running on device 118, as shown in FIG. 1. This control option may include, for example, one of control options 302, 304, and 306, as previously discussed with reference to FIG. 3.

Method 700 may include one or more processors determining the number of prompt layers based upon the received control option (block 704). These one or more processors may include a CPU, such as processor 206, for example, as shown in FIG. 2. In some aspects, method 700 may include a determination being made regarding the information needed to calculate an insurance quote and whether this information is available via one or more databases (block 704). Based upon the amount of data available from the one or more databases and the control option received by the user (block 702), method 700 may include determining the number of prompt layers by determining which prompts may be prepopulated or accessed via one or more databases as opposed to being answered by the user (block 704).

Method 700 may include one or more processors generating one or more prompts (block 706) based upon the number of determined prompt layers (block 704). The one or more processors may include a CPU, such as processor 206, for example, as shown in FIG. 2, which may generate the one or more prompts as data sent to another suitable device, such as device 118, for example, as shown in FIG. 1. Method 600 may include sending data to be displayed as one or more prepopulated prompts (block 706) within a GUI based upon the number of determined prompt layers (block 704) and the received control option (block 702). Method 700 may include omitting one or more prompts and/or sending data to be displayed as one or more prepopulated prompts) based upon the received control option and the type of insurance product to be quoted (block 706).

Method 700 may include one or more processors receiving a first portion of data (block 708) from the user's answer to the prompts (block 706). Again, the one or more processors may include a CPU, such as processor 206, for example, as shown in FIG. 2, which may receive the first portion of data from a device in conjunction with a communication unit, such as communication unit 204, for example.

Method 700 may include one or more processors receiving a second portion of data from one or more sources other than the user and corresponding to prompts not generated (or prepopulated) (block 710). Again, the one or more processors may include a CPU, such as processor 206, for example, as shown in FIG. 2, which may receive the second portion of data from a device in conjunction with a communication unit, such as communication unit 204, for example. The appropriate database from which to retrieve the second portion of data may be determined, for example, in accordance with one or more applications, algorithms, and/or modules, such as database correlation module 212, for example, as shown in FIG. 2. For example, the second portion of data may be retrieved from one or more databases, such as databases 128a-N, as shown in FIG. 1.

Method 700 may include one or more processors calculating an insurance quote (block 712) based upon the selected type of quote requested by the user (block 702). Again, the one or more processors may include a CPU, such as processor 206, for example, as shown in FIG. 2, which may send the calculated insurance quote to a device in conjunction with a communication unit, such as communication unit 204, for example. Method 700 may include displaying the calculated insurance quote on a suitable device (block 712). Methods 600 and 700 may include additional, fewer, or alternate actions, including those discussed elsewhere herein.

### VII. EXEMPLARY INSURANCE QUOTE APPLICATION PROCESS

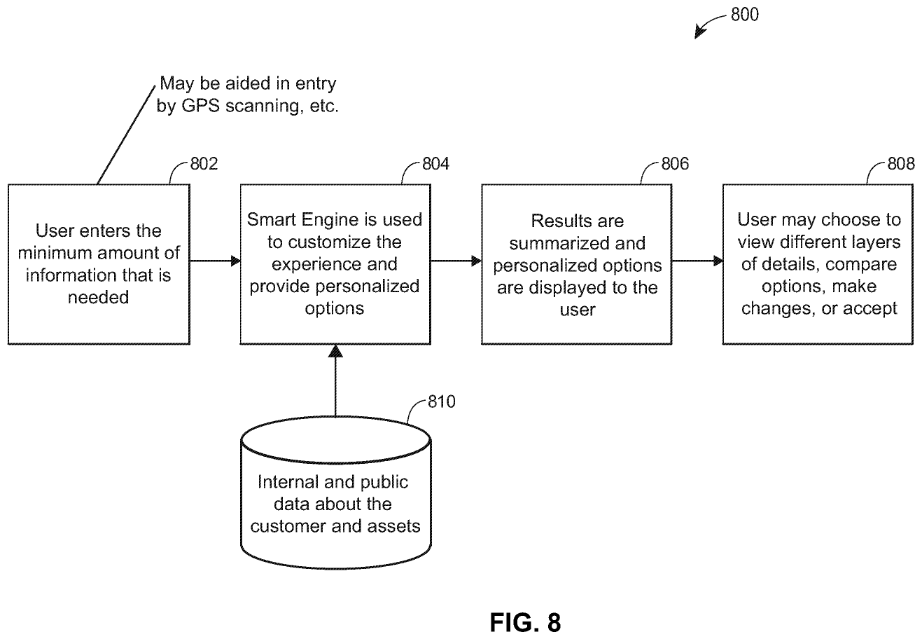

FIG. 8 illustrates a block diagram 800 in accordance with an exemplary aspect of the present disclosure. As shown in FIG. 8, aspects include a user (e.g., a customer) starting the online application process to obtain an insurance policy product quote by providing the minimum amount of information that is needed, as shown in block 802. For example, the user may enter the minimum amount of information via one or more devices 118 of front end 102, as shown in FIG. 1. In an aspect, the minimum amount of information entered by the user may be a result of the user selecting the appropriate control option displayed on a device 118, such as control option 302, for example, as shown in FIG. 3 and/or otherwise being presented with only prompts corresponding to the minimum information. The minimum amount of information may include, for example, the minimum information needed for smart engine 202, for example, as shown in FIG. 2, to accurately determine a premium quote for the user based upon a risk assessment and/or other suitable information.

In an aspect, the minimum information entered by the user may be a result of some information that would otherwise be needed to be entered by the user being retrieved from one or more data sources. For example, as previously discussed, one or more prompts may be prepopulated with the relevant information, such as the user's address, based upon data retrieved with the user's permission from one or more databases. Additionally or alternatively, aspects may include one or more prompts being prepopulated based upon data retrieved from a suitable front end device such that the user does not need to enter the information. For example, if the user is entering the information on a front end device that is configured to determine its geographic location (e.g., via GPS positioning) then aspects include prepopulating one or more fields based upon the customer's home address that may be assumed and/or estimated based upon this location information.

At block 804, aspects may include a smart engine, such as smart engine 202, for example, as shown in FIG. 2, customizing the user's experience and providing personalized options. For example, this may include the smart engine communicating with one or more databases, such as databases 128a-N, for example, as shown in FIG. 1, which is represented by block 810. Aspects of customizing the user's experience may include evaluating the user's selected control option, determining information that may be retrieved from the databases, and information that may be required from the customer in accordance with the selected control option.

At block 806, aspects include the smart engine summarizing the results of information retrieved from one or more databases in accordance with the user's selected control option and displaying personalized options to the user at the appropriate front end device. This may include, for example, the summary display as shown and previously discussed with reference to FIGS. 5A-B, in which a user may be initially presented with one or more prepopulated prompts and information regarding the assumptions that were made that caused the fields to be populated in the manner presented to the customer (e.g., the year of the vehicle, the customer's work and home address, etc.).

At block 808, aspects include allowing the user to choose different layers of details, compare options, make changes, and/or accept the information presented to the user. For example, the customer may be provided with instructions and given the opportunity to change coverage amounts, the estimated annual mileage, the current mileage on the vehicle to be insured, provide information on additional discounts, etc. In this way, aspects include a smart engine providing a customized user experience to allow a customer to choose the amount of control the user wishes to have in the overall application without binding the user to his initial control selection.

### VIII. EXEMPLARY GENERATION OF AN INSURANCE PRODUCT QUOTE

In one aspect, a computer-implemented method for generating an insurance product policy quote may be provided. The method may include: (1) determining, by one or more processors, data to calculate an insurance product quote requested by a user; (2) receiving, by one or more processors, a first portion of the data from one or more sources other than the user; (3) generating, by one or more processors, one or more prompts that have answers corresponding to a second portion of the data that is not available from the one or more sources; (4) receiving, by one or more processors, the second portion of data based upon answers provided by the user to the one or more prompts; (5) calculating, by one or more processors, the insurance product quote based upon the first and second portions of data; and/or (6) generating, by one or more processors, a display of the insurance product quote. The method may include additional, fewer, or alternate actions, including those discussed elsewhere herein.

For instance, the act of determining may include determining the data as a minimum amount of data needed for calculation of the insurance product quote data. The sources of data may include one or more of (1) a database associated with an insurer issuing the insurance product; (2) third parties; (3) publicly available sources; or (4) sources that are not publicly available. The act of generating the one or more prompts may include generating the one or more prompts as part of a web-based application, which may generate the one or more prompts within a plurality of sequentially-generated interactive windows presented to the user, the answers to the one or more prompts corresponding to the second portion of data. The plurality of sequentially-generated interactive windows may be a subset of a larger plurality of sequentially-generated interactive windows, and the subset of the plurality of sequentially-generated interactive windows may be less than the larger plurality of sequentially-generated interactive windows due to a reduction in the data that is needed from the user to calculate the insurance product quote due to the first portion of the data. Answers to one or more prompts included in the larger plurality of sequentially-generated interactive windows may constitute the first portion and the second portion of the data to calculate the insurance product quote.

### IX. EXEMPLARY METHODS OF GENERATING INSURANCE QUOTES

In one aspect, a computer-implemented method for generating an insurance product policy quote may be provided. The method may include: (1) receiving, by one or more processors, a control option indicative of a number of prompts to be answered to obtain an insurance product quote; (2) determining, by one or more processors, a number of prompt layers based upon a control option, each of the number of prompt layers including one or more prompts to be displayed; (3) generating, by one or more processors, one or more prompts within the number of prompt layers as a plurality of sequentially-presented interactive windows such that a user's answers to the one or more prompts while navigating through the plurality of sequentially-presented interactive windows represents a user experience path; (4) receiving, by one or more processors, a first portion of data from the user's answers to the one or more prompts within the user experience path; (5) receiving, by one or more processors, a second portion of data from one or more sources other than the user, the second portion of data corresponding to prompt layers that are not generated based upon the control option; (6) calculating, by one or more processors, the insurance product quote based upon the first and second portion of data; and/or (7) generating, by one or more processors, a display of the insurance product quote. The method may include additional, fewer, or alternate actions, including those discussed elsewhere herein.

For instance, the number of prompt layers may vary between a maximum and a minimum number of prompt layers. The act of determining may include (1) decreasing the number of prompt layers to be presented to the user from a maximum number of prompt layers when the control option indicates the user desires to answer less prompts than the one or more prompts included in the maximum number of prompt layers, thereby decreasing the length of the user experience path; and (2) increasing the number of prompt layers to be presented to the user from a minimum number of prompt layers when the control option indicates the user desires to answer more prompts than the one or more prompts included in the minimum number of prompt layers, thereby increasing the length of the user experience path.

The control option may include a full control option, a partial control option, or a no control option. The selection of the no control option by a user may result in no prompt layers being generated, thereby yielding a minimum user experience path length, whereas the selection of the full control option by the user may result in a maximum number of layers being generated, thereby yielding a maximum user experience path length. Furthermore, the selection of the partial control option by the user may result in the number of layers being generated between a maximum and a minimum number of prompt layers, thereby resulting in the user experience path length being a length that is between a maximum and a minimum user experience path length.

### X. EXEMPLARY NON-TRANSITORY COMPUTER READABLE MEDIUM

In one aspect, a non-transitory, tangible computer-readable medium storing machine readable instructions are described that, when executed by a processor, may cause the processor to: (1) determine data to calculate an insurance product quote requested by a user; (2) receive a first portion of the data from one or more sources other than the user; (3) generate one or more prompts that have answers corresponding to a second portion of the data that is not available from the one or more sources; (4) receive the second portion of data based upon answers provided by the user to the one or more prompts; (5) calculate the insurance product quote based upon the first and second portions of data; and/or (6) generate a display of the insurance product quote. The machine readable instructions may include additional, less, or alternate functionality, including that discussed elsewhere herein.

For instance, the instructions to determine the data to calculate the insurance product quote may further include instructions that when executed by a processor, cause the processor to determine the data as a minimum amount needed for calculation of the insurance product quote data. The sources of data may include one or more of (1) a database associated with an insurer issuing the insurance product; (2) third parties; (3) publicly available sources; or (4) sources that are not publicly available. The instructions to generate the one or more prompts may further include instructions that when executed by a processor, cause the processor to generate the one or more prompts as part of a web-based application, which may include generating the one or more prompts within a plurality of sequentially-generated interactive windows presented to the user, the answers to the one or more prompts corresponding to the second portion of data. The plurality of sequentially-generated interactive windows may be a subset of a larger plurality of sequentially-generated interactive windows, and the subset of the plurality of sequentially-generated interactive windows may be less than the larger plurality of sequentially-generated interactive windows due to a reduction in the data that is needed from the user to calculate the insurance product quote due to the first portion of the data. Answers to one or more prompts included in the larger plurality of sequentially-generated interactive windows may constitute the first portion and the second portion of the data to calculate the insurance product quote.

### XI. ADDITIONAL CONSIDERATIONS

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain aspects are described herein as including logic or a number of components or modules. Modules may constitute either software modules (e.g., code stored on a machine-readable medium) or hardware modules. A hardware module is tangible unit capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In some cases, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering aspects in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In aspects in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example aspects, the processor or processors may be located in a single location (e.g., within a home environment, an office environment or as a server farm), while in other aspects the processors may be distributed across a number of locations.

The one or more processors may also operate to support performance of the relevant operations in a “cloud computing” environment or as a SaaS. For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other example aspects, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one aspect” or “an aspect” means that a particular element, feature, structure, or characteristic described in connection with the aspect is included in at least one aspect. The appearances of the phrase “in one aspect” in various places in the specification are not necessarily all referring to the same aspect.

Some aspects may be described using the expression “coupled” and “connected” along with their derivatives. For example, some aspects may be described using the term “coupled” to indicate that two or more elements are in direct physical or electrical contact. The term “coupled,” however, may also mean that two or more elements are not in direct contact with each other, but yet still co-operate or interact with each other. The aspects are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, condition A or B is satisfied by any one of the following: A is true (or present) and B is false (or not present), A is false (or not present) and B is true (or present), and both A and B are true (or present).

In addition, use of the “a” or “an” are employed to describe elements and components of the aspects herein. This is done merely for convenience and to give a general sense of the description. This description should be read to include one or at least one and the singular also includes the plural unless it is obvious that it is meant otherwise.

Also, the patent claims at the end of this patent application are not intended to be construed under 35 U.S.C. § 112(f) unless traditional means-plus-function language is expressly recited, such as “means for” or “step for” language being explicitly recited in the claim(s).

Upon reading this disclosure, those of ordinary skill in the art will appreciate still additional alternative structural and functional designs for providing an interface to streamline a user's experience with an application through the disclosed principles herein. Thus, while particular aspects and applications have been illustrated and described, it is to be understood that the disclosed aspects are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims. The methods and processes described throughout the present disclosure may be utilized to prepopulate prompts, eliminate prompts, and otherwise streamline a user's experience with an application that may be used to request an insurance quote or any other suitable purpose.

For example, a user may be presented with an original prompt, such as one requesting a vehicle identification number (VIN), for example. If the entered prompt is incorrect or not recognized, then aspects of the present disclosure include presenting the user with alternate prompts that facilitate the entry of the VIN number in different ways. For example, the original VIN prompt may request a text string, while the additionally generated VIN prompts may request the VIN number as a scanned QR code, a scanned barcode, an image, a spoken number, etc.

To provide an additional example of implementations of the described aspects of the present disclosure, a user may be automatically presented with prompts when one or more databases indicate that a user may be a good candidate for other insurance products, thereby facilitating cross product sales.

Furthermore, other examples may include prepopulation of expected moving dates based upon data accessed via one or more databases, the presentation of one or more links to allow the user to quickly access information available from one or more databases, such as user account information associated with policies, accounts, and/or user preferences.

Additional examples may include presenting premiums based upon the user's payment history. In other words, a user who pays monthly may view the quoted premium as a monthly quote, while a user who pays the entire 6 month premium would be presented with a lump sum 6 month quote.

Further examples include recommending an agent for a customer when an updated address has been determined based upon agents available at the user's new location.

We claim:

1. A computer-implemented method of generating a quote of a product for display on a graphical user interface (GUI), the method comprising:
determining, by one or more processors, data to calculate a product quote requested by a user;
receiving, by the one or more processors, a first portion of the data from one or more sources other than the user;
generating, by the one or more processors, one or more prompts for displaying via the GUI to collect answers from the user, the answers corresponding to a second portion of the data that is not available from the one or more sources;
receiving, by the one or more processors, the second portion of data based upon the answers provided by the user to the one or more prompts;
calculating, by the one or more processors, the product quote based upon the first and second portions of data; and
generating, by the one or more processors, a display of the product quote.

2. The computer-implemented method of claim 1, wherein act of determining comprises:
determining the data as a minimum amount needed for calculation of the product quote.

3. The computer-implemented method of claim 1, wherein the one or more sources of data comprise one or more of:
a database associated with an insurer issuing the product;
third parties;
publicly available sources; or
sources that are not publicly available.

4. The computer-implemented method of claim 1, wherein the act of generating the one or more prompts comprises:
generating the one or more prompts as part of a web-based application.

5. The computer-implemented method of claim 4, wherein the act of generating the one or more prompts as part of a web-based application comprises:
generating the one or more prompts within a plurality of sequentially-generated interactive windows presented to the user, the answers to the one or more prompts corresponding to the second portion of data.

6. The computer-implemented method of claim 5, wherein the act of generating the one or more prompts within the plurality of sequentially-generated interactive windows comprises:
generating the one or more prompts within the plurality of sequentially-generated interactive windows as a subset of a larger plurality of sequentially-generated interactive windows, and
wherein the subset of the plurality of sequentially-generated interactive windows is less than the larger plurality of sequentially-generated interactive windows based upon a reduction in the data that is needed from the user to calculate the product quote due to the first portion of the data.

7. The computer-implemented method of claim 6, wherein answers to one or more prompts included in the larger plurality of sequentially-generated interactive windows constitutes the first portion and the second portion of the data to calculate the product quote.

8. A non-transitory, tangible computer-readable medium storing machine readable instructions for generating a quote of a product for display on a graphical user interface (GUI) that, when executed by one or more processors, cause the one or more processors to:
determine data to calculate a product quote requested by a user;
receive a first portion of the data from one or more sources other than the user;
generate one or more prompts for displaying via the GUI to collect answers from the user, the answers corresponding to a second portion of the data that is not available from the one or more sources;
receive the second portion of data based upon the answers provided by the user to the one or more prompts;
calculate the product quote based upon the first and second portions of data; and
generate a display of the product quote.

9. The non-transitory, tangible computer-readable medium of claim 8, wherein the instructions to determine the data to calculate the product quote further include instructions that when executed by a processor, cause the processor to:
determine the data as a minimum amount needed for calculation of the product quote.

10. The non-transitory, tangible computer-readable medium of claim 8, wherein the one or more sources of data comprise one or more of:
a database associated with an insurer issuing the product;
third parties;
publicly available sources; or
sources that are not publicly available.

11. The non-transitory, tangible computer-readable medium of claim 8, wherein the instructions to generate the one or more prompts further include instructions that when executed by a processor, cause the processor to:
generate the one or more prompts as part of a web-based application.

12. The non-transitory, tangible computer-readable medium of claim 11, wherein the instructions to generate the one or more prompts as part of a web-based application further include instructions that when executed by a processor, cause the processor to:
generate the one or more prompts within a plurality of sequentially-generated interactive windows presented to the user, the answers to the one or more prompts corresponding to the second portion of data.

13. The non-transitory, tangible computer-readable medium of claim 12, wherein the instructions to generate the one or more prompts within the plurality of sequentially-generated interactive windows further include instructions that when executed by a processor, cause the processor to:
generate the one or more prompts within the plurality of sequentially-generated interactive windows as a subset of a larger plurality of sequentially-generated interactive windows, and
wherein the subset of the plurality of sequentially-generated interactive windows is less than the larger plurality of sequentially-generated interactive windows based upon a reduction in the data that is needed from the user to calculate the product quote due to the first portion of the data.

14. The non-transitory, tangible computer-readable medium of claim 13, wherein answers to one or more prompts included in the larger plurality of sequentially-generated interactive windows constitutes the first portion and the second portion of the data to calculate the product quote.

15. A computer-implemented method of generating a quote of a product for display on a graphical user interface (GUI), the method comprising:
receiving, by one or more processors, a control option indicative of a number of prompts to be answered to obtain a product quote;
determining, by the one or more processors, a number of prompt layers based upon a control option, each of the number of prompt layers including one or more prompts to be displayed via the GUI;
generating, by the one or more processors, one or more prompts within the number of prompt layers as a plurality of sequentially-presented interactive windows such that a user's answers to the one or more prompts while navigating through the plurality of sequentially-presented interactive windows represents a user experience path;
receiving, by the one or more processors, a first portion of data from the user's answers to the one or more prompts within the user experience path;
receiving, by the one or more processors, a second portion of data from one or more sources other than the user, the second portion of data corresponding to prompt layers that are not generated based upon the control option;
calculating, by the one or more processors, the product quote based upon the first and second portion of data; and
generating, by the one or more processors, a display of the product quote.

16. The computer-implemented method of claim 15, wherein the number of prompt layers varies between a maximum and a minimum number of prompt layers, and
wherein the act of determining comprises:
decreasing the number of prompt layers to be presented to the user from a maximum number of prompt layers when the control option indicates the user desires to answer less prompts than the one or more prompts included in the maximum number of prompt layers, thereby decreasing the length of the user experience path; and
increasing the number of prompt layers to be presented to the user from a minimum number of prompt layers when the control option indicates the user desires to answer more prompts than the one or more prompts included in the minimum number of prompt layers, thereby increasing the length of the user experience path.

17. The computer-implemented method of claim 15, wherein the control option comprises:
a full control option;
a partial control option; or
a no control option.

18. The computer-implemented method of claim 17, wherein the selection of the no control option results in no prompt layers being generated, thereby yielding a minimum user experience path length.

19. The computer-implemented method of claim 17, wherein the selection of the full control option results in a maximum number of layers being generated, thereby yielding a maximum user experience path length.

20. The computer-implemented method of claim 17, wherein the selection of the partial control option results in the number of layers being generated between a maximum and a minimum number of prompt layers, thereby resulting in the user experience path length being a length that is between a maximum and a minimum user experience path length.
